(19) United States
(12) Patent Application Publication
(10) Pub. No.: US 2020/0275668 A1
(43) Pub. Date: Sep. 3, 2020

(54) OVEN AND METHOD FOR BAKING CHEESE-BASED FOOD PRODUCTS

(71) Applicant: SLB S.R.L., Brescia (IT)

(72) Inventor: Francesca SANGIACOMO, Brescia (IT)

(73) Assignee: SLB S.R.L., Brescia (IT)

(21) Appl. No.: 16/762,248

(22) PCT Filed: Nov. 8, 2018
(86) PCT No.: PCT/IB2018/058779

§ 371 Date: May 7, 2020

(30) Foreign Application Priority Data
Nov. 10, 2017 (IT) 102017000128253

(51) Int. Cl. A21B 3/04; A23C 19/09; A23L 3/40; F26B 3/347; F26B 15/18; F26B 21/08; F26B 21/12; A21B 1/48; A21B 2/00

(52) U.S. Cl. CPC A21B 3/04; A23C 19/0912; A23L 3/40; F26B 3/347; A21B 2/00; F26B 21/08; F26B 21/12; A21B 1/48; F26B 15/18

(57) ABSTRACT

A method and baking oven (1) for baking food products comprising cheese or constituted by cheese are described. The baking oven comprising a baking chamber (2), a conveyor belt (3) movable in a continuous way in the baking chamber for supplying the ingredients and for unloading the food products, heating means (4) to heat the ingredients in the baking chamber and extracting means (9) to extract air and vapor from the baking chamber, which are configured to obtain a food product having residual humidity of less than 5% by weight and a consequent shelf-life longer than 4 months.

### FIELD OF THE INVENTION

The present invention concerns the sector of industrial ovens for baking food products and, in particular, an oven and a method for baking cheese-based food products.

### STATE OF THE ART

The sector of baked food products of the packaged type is particularly relevant; in specific, the sector of light meals, also named snacks, is increasingly growing. The so-called shelf-life, i.e. the time period within which the food is hygienically suitable for consumption if maintained under the proper preservation conditions, is a very important parameter for these types of products, in particular for marketing and distribution reasons. Normally, a shelf-life of at least 4 months from production date, preferably of at least 12 months, in particular for products intended to be exported, is required for snacks. Moreover, these should preferably be preserved outside of the refrigerator to simplify and reduce transport and storage costs.

Ovens, comprising at least one baking chamber in which the product to be baked and heating means to bake the product are arranged, can be used for these types of products.

Traditional ovens can be static, i.e. only provided with heating means, or ventilated, i.e. provided with means to generate a flow of air inside the baking chamber in order to obtain a better diffusion of the heat. However, this ventilation does not prevent the baking chamber from becoming saturated with the water vapor produced while baking the food products.

In particular, in case of cheese-based food products or anyhow of ingredients having a high moisture content, i.e. higher than or equal to 25% of their weight, the food must also be dehydrated while baking so that to remove a high percentage of its initial moisture.

The expression “cheese-based food products” concerns food products whose ingredients comprise cheese for at least 50% of their total weight. The description will refer to cheese-based food products, without however excluding other ingredients with high moisture content. Moreover, the cheese used can be of the plant-based type.

In order to be pleasant for the consumer, baked cheese-based food products must be crumbly and crunchy, and they must maintain these characteristics throughout their shelf-life.

In the case of cheese-based food products, it was noticed that a baked food product with high residual moisture causes the product to deteriorate over time, in particular in terms of consistency. In fact, the product tends to become hard and rubbery, rather than crumbly and crunchy. Moreover, in the case of cheese-based baked products, also named dry products, too much residual moisture causes the rancidity of the food over time.

In fact, analyses and checks have demonstrated that residual moisture in the baked food product of more than 5% can cause a deterioration of the organoleptic properties of the product over time, even if suitably preserved, already one month following the date of production, and this deterioration is gradual and increasing with the passing of time. Obviously, this drawback is particularly disadvantageous for food products with a medium to long preservation of the type considered herein and which have a shelf-life of at least 4 months, preferably of 12 months.

Moreover, cheese also has a relevant fat content and therefore the vapor that must be extracted from the food while baking is associated with fat particles and is therefore heavy and tends to stagnate on the surface of the food itself, not allowing the effective and homogeneous removal of the moisture in the whole food product, with consequent disadvantages with respect to the proper shelf life, over time, of the food product obtained.

The document US 2015/264947 concerns a process for producing dry sausages, comprising a rapid partial drying of sausage parts. After the steps necessary for the preparation of the sausage parts, the process comprises their fermentation, the thermal treatment of the sausage parts, their positioning on a conveyor, the passage of the conveyor belt and sausage parts through a chamber and the drying of the sausage parts already partially desiccated. The process also includes the inlet air flow of conditioned air in the chamber, having a relative humidity lower than about 60% and a temperature between about 40° F. and 130° F., and the introduction of microwaves in the chamber. The supply of air and microwaves, as the drying conditions, are set to reduce the moisture content of the meat to a predefined moisture/protein ratio.

### SUMMARY OF THE INVENTION

Object of the present invention is to provide a baking oven and method for producing baked cheese-based food products that allow to overcome the aforesaid drawbacks and to effectively remove the moisture from the baked food product.

A further object is to provide a baking oven that allows the homogeneous baking and dehydration of the whole food product obtained.

A further object is to provide a baking oven that allows to obtain a cheese-based food product with a shelf-life of at least 4 months outside of the refrigerator, without requiring additional additives or preservatives, and which maintains its organoleptic properties until the expiration date.

In its first aspect, the present invention therefore concerns a baking oven according to claim 1 for baking and preparing food products comprising cheese or entirely constituted by cheese.

In particular, the baking oven comprises a baking chamber, a conveyor belt movable in the baking chamber for supplying and unloading food products, heating means to heat the food products in the baking chamber, which are preferably adjustable, for example microwaving means, extracting means to extract air and vapor from the baking chamber and a control unit provided with program means. The baking chamber is insulated from the outside, except for an inlet and an outlet for the conveyor belt.

Advantageously, the flow rate of the extracting means is adjusted by program means so that, during operations, to extract from the baking chamber a flow rate Q of air and water vapor equal to or higher than:

$$Q = \frac{V}{{( {U}_{OUT} - {U}_{IN} )}^{*} {d}_{A}}$$

where:

Q is the volumetric flow rate of air and water vapor to be withdrawn from the baking chamber per each kilogram of food products passing through the baking chamber itself,

V is the amount of water vapor to be removed per each kilogram of food product passing through the baking chamber,

U_{IN} is the specific humidity of the air entering the baking chamber,

U_{OUT} is the specific humidity of the air withdrawn from the baking chamber,

d_{A} is the air density,

wherein the vapor amount V is the difference between the water content X_{IN} in each kilogram of food product to be baked, inserted in the baking chamber, and the water content X_{OUT} being in each kilogram of baked food product extracted from the baking chamber, where V=X_{IN}−X_{OUT}, with X_{OUT}<50 grams.

The suggested solution allows to obtain, at the outlet of the baking chamber, a baked food product having residual moisture lower than 5% by weight and, therefore, a shelf-life of more than four months at room temperature.

In other words, taking care of operating the oven as described above guarantees that the baked food product is sufficiently dehydrated to last for long time outside of the refrigerator, more than 4 months. This simplifies the logistics related to the food product, which can simply be packaged and shipped without requiring refrigeration.

Moreover, the low residual moisture, lower than 5%, maintains the baked food product crumbly and crunchy and therefore desirable for consumers through the whole shelf-life thereof.

Preferably, the extracting means are sized to extract at least 20 m³ of air and vapor per each kilogram of food product passing through the baking chamber. If required, the extracting means are adjustable to extract a higher flow rate.

For example, for the calculation of the flow rate Q, it is possible, in a first approximation, to consider the air density value d_{A} in standard conditions (pressure 1 atmosphere and temperature 25° C.), equal to 1.225 kg/m³.

Preferably, the oven also comprises air inflow means for the air inflow into the baking chamber. In the preferred embodiment, the inflow means are at least arranged next to the inlet of the baking chamber. Therefore, advantageously, the air entered the baking chamber is mixed with the humidity, in the vapor form, emitted by the food products in transit; the air and vapor are extracted by extracting means. In an embodiment, the air inflow means comprise at least one environmental control battery for the inlet air flow of treated air, having a predefined temperature and/or humidity, in the baking chamber.

Alternatively, the air inflow into the baking chamber can be directly forced by extracting means, which suck the air in the baking chamber through the inlet and outlet for the conveyor belt.

Generally, if the air introduced into the baking chamber is ambient air, the specific humidity of the air introduced into the baking chamber can be measured with suitable and easy to find tools on the market; instead, if the air was introduced into the baking chamber through specific treatment units or batteries, the specific humidity value of the inlet air flow is imposed by these means.

Preferably, the air inflow means are configured to direct, onto the surface of the conveyor belt, an inlet air flow intercepting the conveyor belt for its whole width. Similarly, the extracting means are configured to extract a flow of air and vapor by intercepting the whole width of the conveyor belt. For example, the inflow means and the extracting means respectively comprise at least one inflow port and at least one outflow port extending along the whole width of the conveyor belt.

In the preferred embodiment, the air inflow means comprise at least one inflow port fluidically connected with a fan, and the extracting means comprise at least one outflow port fluidically connected with at least one suctioning device. The inflow and outflow ports intercept the whole width of the conveyor belt and are spaced from one another at a distance equal to at least half of the length of the baking chamber. This configuration creates a flow of air and vapor onto the surface of the conveyor belt next to its whole width and next to at least half of the length of the baking chamber, preferably the half of the conveyor belt next to an initial and intermediate baking step of the food products.

Preferably, the flow of air covers at least two thirds of the length of the conveyor belt and even more preferably covers almost the whole length of the conveyor belt in the baking chamber.

Therefore, advantageously, the air introduced into, or entering, the baking chamber intercepts the surface of the food product being baked, mixes with the vapor escaping from it and is sucked with it by the suctioning means, preventing the air of the baking chamber from becoming vapor saturated and therefore allowing a further removal of vapor from each food product, until reaching residual moisture equal to or lower than 5% in the baked food products ready to be packaged.

In other words, the presence of the inflow and outflow ports configured to intercept the whole width of belt allows the formation of an air blade running along the surface of the food product being baked, thus removing the humidity gradually extracted thanks to the heating means, in order to obtain a more effective and homogeneous removal of moisture from the food product, also from its bottom part that is leaned against the conveyor belt.

Preferably, the inlet air flow and the outlet air and vapor flow are laminar.

Preferably, the oven comprises adjusting means to adjust the flow rate of the air entered by the inflow means and the flow rate of the air and vapor extracted by the extracting means, for example valves, shutters or speed regulators of the extractor fans or blowers. Optionally, the inflow means and/or extracting means are combined with air filtering means.

Preferably, the oven is maintained slightly depressurized by taking care of maintaining the inlet air flow rate lower than the outlet air and vapor flow rate. This circumstance favors the extraction of vapor and, if applicable, an expansion of the food product being baked and the formation of small cavities, in particular in baked cheese, which make the food product obtained particularly crunchy.

In the preferred embodiment, the extracting means comprise a plurality of outlet ports fluidically connected with one or more suctioning devices. Each outlet port withdraws a corresponding part of the air and vapor flow rate extracted from the baking chamber. The outlet ports are prearranged aligned along the belt and/or side by side to extract the air and vapor from several points of the baking chamber so that to remove the humidity more effectively, as it is gradually extracted from the food product while passing through the baking chamber.

Moreover, filtering means combined with inflow means and/or extracting means can be provided so that the air introduced is filtered and suitable for coming into contact with the food during the baking step and/or so that fat particles or other can be removed from the outlet air flow of the baking chamber in order to allow it to disperse it without polluting.

Preferably, the heating means are of the microwave type, since these are particularly adapted to quickly extract moisture from cheese; this allows to dehydrate the food product without drying or burning it.

Alternatively or in addition, the heating means can comprise means suitable for generating and irradiating heat, such as electric resistances and/or infrared heaters.

Optionally, the baking chamber can be constituted by at least two baking sub-chambers, for example of the modular type, provided with removable layers for their cleaning.

In an alternative solution, the air is also heated with electric resistances in addition to the microwaves. The hot air introduced into baking chamber assists the microwaves, thus improving and speeding up the baking of the product. The temperature of the air inflow is adjustable, as well as the power of the microwaves and the speed of the conveyor belt, in order to change the baking parameters according to the recipe and the type of ingredients of the food product being baked.

Preferably, the conveyor belt is closed-loop shaped and combined with a first and a second movement roller. This way, it is possible to produce the food product in a continuous way and to easily unload the food product from the belt and onto the second roller by overturning. In a preferred solution, the rollers are movable between one another, in the sense of moving them closer or away by means of actuators, preferably of the pneumatic type; this way, it is possible to maintain the conveyor belt tensioned while baking, by balancing any possible expansion due to the heat and loosening the tension of the belt when the oven is off, in order to reduce wear and to facilitate the cleaning and maintenance steps.

Advantageously, the conveyor belt can be combined with position sensors in order to check the correct centering, and the actuators can be driven according to the data detected by the position sensors in order to maintain the belt centered with respect to the movement rollers.

In addition, cleaning means, washing means and drying means of the conveyor belt can be combined with a lower part of the oven, in order to carry out these operations in a continuous way.

A second aspect of the present invention concerns the method according claim 16 for baking food products comprising cheese or entirely constituted by cheese.

The method can be implemented by means of a baking oven having the aforesaid characteristics and therefore comprising a baking chamber closed except for an inlet and an outlet, a conveyor belt movable in the baking chamber for supplying food products to be baked and unloading baked food products, heating means to heat the food products in the baking chamber, extracting means to extract the air and vapor from the baking chamber and a control unit provided with program means.

The method comprises:

a) baking the food products in the baking chamber by the heating means, for example microwaves, by extracting moisture, in the vapor form, from them;

b) programming the flow rate of the extracting means through the control unit until they extract, from the baking chamber, a flow rate Q of air and vapor equal to, or higher than:

$$Q = \frac{V}{{( {U}_{OUT} - {U}_{IN} )}^{*} {d}_{A}}$$

where:

Q is the volumetric flow rate of air and vapor to be withdrawn from the baking chamber per each kilogram of food products passing through the baking chamber itself,

V is the amount of vapor to be removed per each kilogram of food product passing through the baking chamber,

U_{IN} is the specific humidity of the air entering the baking chamber,

U_{OUT} is the specific humidity of the air withdrawn from the baking chamber,

d_{A} is the air density.

The vapor amount V is the difference between the water content X_{IN} in each kilogram of food product to be baked, inserted in the baking chamber, and the water content X_{OUT} being in each kilogram of baked food product extracted from the baking chamber, where V=X_{IN}−X_{OUT}, with X_{OUT}<50 grams.

The method allows to obtain a food product having residual moisture lower than 5% by weight and a shelf-life of more than four months at room temperature.

Therefore, and advantageously, the combined action of baking the food product through the heating means, which cause an outflow of vapor from the cheese, and the removal of the vapor from the baking chamber thanks to the extracting means, allows to remove high amounts of humidity, without allowing the vapor to saturate the baking chamber, until reaching residual moisture in the baked food product equal to or lower than 5% of its weight.

Preferably, the heating means are of the microwave type, but other types of heating means used in the baking oven of the food sector are not to be excluded.

Advantageously, the flow rate Q is equal to at least 20 m³ per each kilogram of food product passing through the baking chamber.

Preferably, whenever the oven comprises air inflow means for the inflow of air into the baking chamber, the method can also provide an air inflow in the baking chamber by setting the flow rate of the inflow means depending on the flow rate set for the extracting means. Preferably, the flow rate of the inflow means is increased/decreased at the increase/decrease of the flow rate of the extracting means, so that it is lower than the flow rate of the extracting means in order to maintain the baking chamber depressurized.

### BRIEF DESCRIPTION OF THE FIGURES

Further characteristics and advantages of the invention will be better highlighted by the review of the following specification of a preferred, but not exclusive, embodiment illustrated for illustration purposes only, and without limitations, with the aid of the accompanying drawings, wherein:

FIG. 1 is a schematic view of a baking oven according to the present invention;

FIG. 2 shows a perspective view of part of the oven in FIG. 1;

FIG. 3 is a front view of a component of the oven shown in FIG. 1.

### DETAILED DESCRIPTION OF THE INVENTION

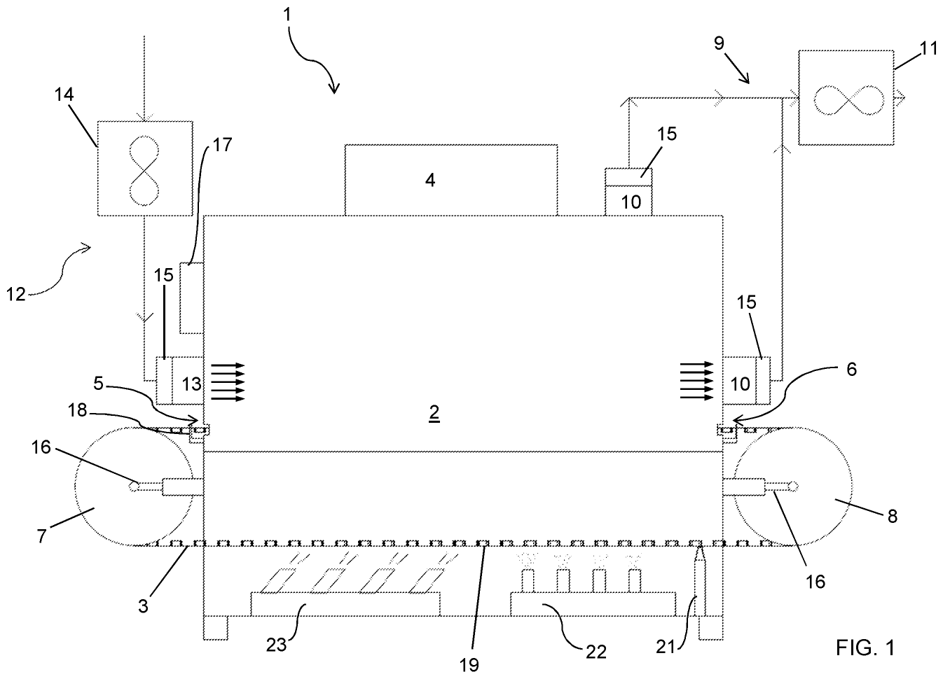

FIG. 1 is a schematic view of a baking oven 1 according to the present invention for baking food products containing cheese or entirely constituted by cheese.

FIG. 2 is a schematic, perspective and partially transparent view of a baking oven 1 according to the present invention.

Specifically, the baking oven 1 is configured to bake and dehydrate food products having a high initial moisture content and, in particular, cheese; the baked food product produced by the oven 1 is entirely constituted by, or comprises a high percentage of—at least 40% of the weight—baked or dehydrated cheese.

The oven 1 comprises a baking chamber 2, a conveyor belt 3 movable in a continuous way in the baking chamber 2 for supplying the food product and for unloading the baked food product, and heating means 4 for baking the food products passing through the baking chamber 2 on the conveyor belt 3.

The baking chamber 2 has an inlet 5 and an outlet 6 to allow the passage of the conveyor belt 3; for the rest, it is completely closed, i.e. insulated from the outside environment. In order to facilitate the inspection and cleaning, the baking chamber 2 can have one or more openable portions, not shown. In addition, the baking chamber 2 can be a single block or subdivided in sub-chambers.

The conveyor belt 3 can be constituted of trays movable in the baking chamber 2 by movement means, for example chains or belts, or—as shown in the figures—closed-loop shaped and provided with molds, combined with a first movement roller 7 and with a second movement roller 8, at least one of which is motorized. The first roller 7 and the second roller 8 are respectively arranged upstream and downstream of the baking chamber 2. The conveyor belt 3 is movable in a continuous way or intermittently in the baking chamber, and its speed can be adjusted as needed.

The heating means 4 are suitable for the baking and dehydration of the food products, thus causing the outflow of moisture, in the vapor form, from the cheese. Preferably, the heating means 4 are of the microwave type and/or can comprise electric resistances and/or infrared heating means.

According to the invention, the oven 1 is provided with extracting means 9 to withdraw air and vapor from the baking chamber 2 during the operations of the oven 1. The extracting means comprise at least one outflow port 10 connected to at least one suctioning device 11, two outflow ports 10 are visible in FIG. 1. The outflow ports 10 withdraw the air mixed to the vapor in several points of the baking chamber 2, by removing the vapor as it gradually forms. Preferably, an outflow port 10 is provided at the outlet of the baking chamber 2 and at least one outflow port 10 is provided in an intermediate position; in case of more outflow ports 10, a suctioning device 11 can be provided connected to several outflow ports 10, as shown in FIGS. 1 and 2, or a suctioning device 11 can be provided for each outflow port 10.

The extracting means 9 are configured so that to withdraw the flow rate of air and vapor from the baking chamber 2 that is suitable for preventing the vapor extracted from the cheese being baked from saturating the baking chamber 2.

Specifically, the extracting means are sized so that to extract at least of 20 m³ of air and vapor per each kilogram of cheese passing through the baking chamber. In fact, the sizing of the suctioning means depend on the amount and zo initial moisture of the cheese, or anyhow of the ingredients of the food product passing through the baking chamber 2, on the amount of residual moisture in the food product after baking 2 and on the amount of humidity that can be contained in each m³ of air extracted from the baking chamber 2, amount that can be determined by using a psychrometric diagram and from the amount of cheese that can pass in the baking chamber 2. In order to obtain a food product with stable characteristics over time, it was detected that the optimal residual moisture must be equal to or lower than 5% of its weight.

More in detail, the flow rate Q of air and vapor to be extracted from the baking chamber per each kilogram of food product passing through the baking chamber 2 can be determined according to the following values:
amount of vapor V to be removed from each kilogram of food product passing through the baking chamber 2; this amount is obtained as the difference between the moisture of the cheese X_{IN} and the moisture of the food product X_{OUT}, which, as described above, must be 5% maximum. For example, for a cheese-only food product with moisture of 35%, i.e. a water content of 350 grams per each kilogram, at least 300 grams of water must be evaporated to obtain a food product with a water content of 50 grams maximum.
difference between the specific humidity of the outflow air U_{OUT} from the baking chamber 2 and the specific humidity of the incoming air U_{IN} in the baking chamber 2; in other words, in order to know how many grams of vapor V emitted from the food product being baked can be contained in each kilogram of air extracted from the baking chamber, the amount of vapor already present in the inlet air flow of the air inflow in the baking chamber 2 and the maximum vapor amount that can be contained in the air extracted by the baking chamber 2 must be considered in order to avoid reaching the saturation point at which the vapor would condense. In turn, the values of U_{OUT} and U_{IN} depend on the temperature and humidity of the outlet and inlet air flow.
density of air d_{A} corresponding to the ratio between the air mass and volume it occupies; it is expressed in kilograms per cubic meter and assumed to be equal to 1.225 kg/m³ in standard conditions, i.e. at the pressure of 1 atm, 0% of humidity and temperature of 15° C.

The flow rate Q of air and vapor extracted from the baking chamber 2 per each kilogram of food product can be calculated with the formula described in the summary of the invention:

$$Q = \frac{V}{{( {U}_{OUT} - {U}_{IN} )}^{*} {d}_{A}}$$

to obtain a food product with a moisture of 5% maximum by weight. This way, once packaged, the food product can be preserved for at least four months outside of the refrigerator, maintaining high organoleptic properties over time.

The inflow of air in the baking chamber can be caused by the same extracting means 9 and can occur through the inlet 5 and outlet 6 of the baking chamber. Preferably, however, the oven 1 also comprises air inflow means 12 that introduce an air flow into the baking chamber 2, represented by the arrows in FIG. 2. The air inflow means comprise at least one air inflow port 13 connected to at least one fan 14 in order to push the air into the baking chamber 2 through the inflow port 13 arranged in proximity of the inlet 5 of the baking chamber.

The inflow 13 and outflow 10 ports are configured to generate a flow of air covering the whole width of the conveyor belt 3 so that to mix with the moisture leaving the food product being baked at the level of the whole width Y of the belt. In addition, the ports 10 and 13 are arranged so that the flow of air extends along at least one half, preferably along the whole length X of the conveyor belt 3 in the baking chamber 2. Preferably, laminar air flows are established to remove moisture more effectively from the whole surface of the food product being baked, with respect to the so-called turbulent flows, in which vortex structures, which could put the vapor extracted back in contact with the food product on the conveyor belt 3, are formed.

Respective filtering means 15 can be combined with each inflow and outflow port for the inflow of air in the baking chamber 2 that is suitable for coming into contact with the food product and to withhold the fat particles and/or cheese particles from the air extracted from the baking chamber 2.

The extracting means 9 and possibly the inflow means 12 are provided with means for adjusting the flow rate of the air extracted and introduced according to need, depending on the recipe being baked or on the baking conditions. This way, it is also possible to adjust the inlet and outlet air flow so that to slightly depressurize the baking chamber 2; in fact, this condition favors the expansion of the food product and the formation of little air cavities that make it particularly crunchy.

The heating means 4 can be of the microwave type to quickly obtain the removal of high amounts of humidity from the food product, typically between 4 and 10 minutes. This allows to suitably dehydrate the food product while preventing the cheese from curing/burning. Alternatively or in addition, the heating means can comprise electric resistances and/or be of the infrared type.

In addition, air heating devices—not shown—can be combined with the inflow means so that to obtain the inflow of hot air in the chamber in order to assist the baking and removal of the vapor, and to carry out a combined hot air and microwave baking. The air heating devices can comprise electric resistances. Alternatively or in addition, an air treatment unit, suitable for an inflow of air of the desired temperature and humidity in the baking chamber, can be combined to the inflow means.

Respective actuators 16 can be combined with the first and/or second roller 7, 8, preferably of the pneumatic type and which operate to maintain the conveyor belt 3 tensioned while baking in order to avoid the rollers from slipping. In fact, while baking, due to the heat, the conveyor belt can suffer expansions, which are compensated by a displacement of the rollers caused by the actuators 16. Moreover, the actuators 16 can be driven to bring the rollers 7, 8 closer to one another, once the baking has been completed, to bring the conveyor belt 3 in a resting condition, in which it is not tensioned in order to prevent it from wearing.

The baking oven 1 further comprises a control unit 17 provided with program means to adjust the flow rate of the air inflow means and air extraction means, the temperature of the air to be introduced into the baking chamber 2, the power of the heating means, the movement speed of the conveyor belt 3 and the actuators 16.

In addition, position sensors 18 can be provided at the conveyor belt 3 to detect its position and to send the values detected to the control unit 17, which reprocesses them through the program means to check for any possible side displacements of the belt 3 with respect to its centered position. This way, if the belt 3 is not correctly centered, the control unit 17 can act on the actuators 16, by driving them so that to maintain the belt in the correct position.

The conveyor belt 3 can comprise a plurality of molds 19 for containing the initial ingredients and arranged so that to form a plurality of longitudinal lines L₁, L₂ . . . Lₙ extending along the whole length of the belt and side by side to one another in the direction of the width of the belt. The molds 19 are practically useful whenever the initial ingredient is grated cheese, mixed or not with other ingredients, but also in case of cheese pieces in order to confer a regular shape to the food product.

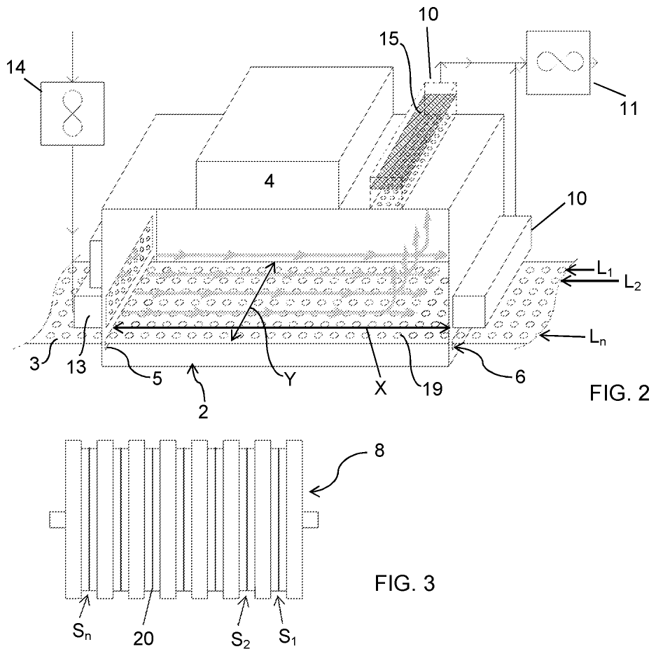

With reference to FIG. 3, correspondingly at the level of the outer surface of the first and second rollers 7, 8, a plurality of grooves S₁, S₂ . . . Sₙ are obtained, each shaped and sized to receive a respective line of molds.

The grooves of the second roller 8 can also have a raised portion 20 in one of their intermediate positions and which deforms the lower surface of the molds in order to facilitate the unloading of the product from the mold by overturning it on the roller itself.

Returning to FIGS. 1 and 2, the oven can comprise cleaning means 21, washing means 22 and drying means 23 arranged on its lower part, at the return path of the belt 3 between the second and first roller. The cleaning means 21 can comprise at least one scraper, the washing means 22 can be constituted by a series of nozzles for the outflow of vapor and the drying means 23 can be constituted by a series of hot air outflow channels.

The baking oven 1 described above can be used for baking the food products according to the following steps:
baking the cheese and possible other ingredients in the baking chamber 2 through the heating means 4;
extracting a flow rate Q of air and vapor by the extracting means 9 from the baking chamber 2 in an amount equal to or higher than:

$$Q = \frac{V}{{( {U}_{OUT} - {U}_{IN} )}^{*} {d}_{A}}$$

wherein the flow rate Q is preferably equal to at least of 20 m³ of air and vapor per each kilogram of food product in the baking chamber 2;
repeating the preceding steps until obtaining a food product with a maximum residual moisture equal to 5% of its weight, in order to obtain a food product that can be preserved for at least 4 months outside of the refrigerator.

The parameters V, U_{OUT}, U_{IN} and d_{A} correspond to the above description with reference to the baking oven.

Whenever the oven is provided with air inflow means for the air inflow into the baking chamber, the method can provide a further step of adjusting the flow rate of air inflowing in the baking chamber as the flow rate of air extracted varies. In fact, on the basis of an increase/decrease of the value of the flow rate of air extracted, it is possible to vary, in the sense of increasing/decreasing, also the flow rate of the air introduced, preferably so that the flow rate of the air introduced is lower than the flow rate of the air extracted, in order to maintain the baking chamber slightly depressurized.

1. A baking oven (1) for baking food products comprising cheese or constituted by cheese, the oven comprising:
a baking chamber (2),
a conveyor belt (3) movable in the baking chamber (2) for supplying and unloading food products,
heating means (4) to heat the food products in the baking chamber, said heating means being selected selected from the group consisting of: microwave heating, infrared heating, electric resistance heating, and combinations thereof,
extracting means (9) to extract air and vapor from the baking chamber,
wherein the baking chamber is insulated from the outside, except for an inlet (5) and an outlet (6) of the conveyor belt (3), and
a control unit (17) comprising program means programmed to adjust the flow rate of said extracting means (9) so that said extracting means (9) extract, from the baking chamber, a flow rate Q of air and vapor equal to or higher than:
$$Q = \frac{V}{{( {U}_{OUT} - {U}_{IN} )}^{*} {d}_{A}}$$
where:
Q is the volumetric flow rate of air and vapor to be withdrawn from the baking chamber (2) per each kilogram of food products passing through the baking chamber (2) itself,
V is the amount of vapor to be removed per each kilogram of food product passing through the baking chamber (2),
U_{IN} is the specific humidity of the air entering the baking chamber (2),
U_{OUT} is the specific humidity of the air withdrawn from the baking chamber (2),
d_{A} is the air density,
wherein the vapor amount V is the difference between the water content X_{IN} in each kilogram of food product to be baked, inserted in the baking chamber (2), and the water content X_{OUT} being in each kilogram of baked food product extracted from the baking chamber (2), where V=X_{IN}−X_{OUT}, with X_{OUT}<50 grams,
to obtain a baked food product having residual moisture lower than 5% by weight and shelf-life longer than four months at room temperature.

2. The baking oven (1) according to claim 1, wherein the extracting means (9) extract a minimum of 20 m³ of air and vapor per each kilogram of food product passing through the baking chamber (2).

3. The baking oven (1) according to claim 1, wherein d_{A} is equal to 1.225 kg/m³.

4. The baking oven (1) according to claim 1, further comprising air inflow means (12) for the air inflow into the baking chamber (2), which are preferably arranged next to at least one inlet (5) of the baking chamber (2).

5. The baking oven (1) according to claim 4, wherein the air inflow means direct, onto the surface of the conveyor belt (3), an inlet air flow intercepting the whole width of the conveyor belt (3), and the extracting means (9) are configured to extract an air and vapor flow by intercepting the whole width of the conveyor belt (3).

6. The baking oven according to claim 4, wherein the air inflow means (12) comprise at least one inflow port (13) fluidically connected with a fan (14) and the extracting means (9) comprise at least one outflow port (10) fluidically connected with at least one suctioning device (11), said inflow and outflow ports intercepting the whole width of the conveyor belt (3) and being spaced from one another so that the air and vapor flow extends onto the surface of the conveyor belt (3) at the whole width thereof and at least for half the length of the baking chamber (3).

7. The baking oven (1) according to claim 6, wherein said inlet air flow and said outlet air and vapor flow are laminar.

8. The baking oven (1) according to claim 4, wherein adjusting means to adjust the flow rate of the air entered by the inflow means and the flow rate of the air and vapor extracted by the extracting means, are provided, and wherein air filtering means (15) are combinable with the inflow means, the extracting means, or both the inflow means and the extracting means.

9. The baking oven (1) according to claim 4, wherein the air entered in the baking chamber (2) by the airflow means is ambient air and the inflow means are provided with means for measuring the specific humidity of the incoming air U_{IN} or, alternatively, treating means to treat the air are combined with the inflow means, for the inflow of air having a given specific humidity U_{IN} in the baking chamber (2).

10. The baking oven (1) according to claim 4, wherein the inlet air flow rate is lower than the outlet air and vapor flow rate, and the baking chamber (2) is maintained slightly depressurized to aid the vapor extraction and the expansion of the food products.

11. The baking oven (1) according to claim 1, wherein the extracting means comprise a plurality of outflow ports (10) fluidically connected with one or more suctioning devices (11), wherein each outflow port (10) withdraws a corresponding part of the air and vapor flow rate extracted from the baking chamber (2).

12. The baking oven (1) according to claim 1, wherein the air inflow means are combined with heating means to heat the inlet of air for the air inflow into the baking chamber (2), said heating devices being adjustable.

13. The baking oven (1) according to claim 1, wherein the conveyor belt (3) is of closed loop type and is combined with a first and a second movement roller (7, 8), the rollers being provided with actuators (16) to change their distance so that, during the baking, the conveyor belt (3) is always tensioned, thereby balancing possible expansions of the conveyor belt (3), and that the rollers are moved closer, thereby reducing the tension of the conveyor belt (3) when necessary.

14. The baking oven (1) according to claim 13, wherein one or more position sensors (18) are provided to detect the position of the conveyor belt (3), and wherein the actuators (16) of the rollers can be driven for feedback keeping the conveyor belt (3) centered, on the basis of the position signals the position sensors detected.

15. The baking oven (1) according to claim 1, wherein at the bottom part of the oven, at the return path of the conveyor belt (3), cleaning means (21), washing means (22) and drying means (23) of the conveyor belt (3) are combined.

16. A method of cooking food products comprising cheese or constituted by cheese, by a baking oven (1) comprising a baking chamber (2) closed except for an inlet (5) and an outlet (6), a conveyor belt (3) movable in the baking chamber for supplying food products to be baked and unloading baked food products, heating means (4) to heat the food products in the baking chamber (2), said heating means (4) being selected from the group consisting of: microwave heating, infrared heating, electric resistance heating means, and combinations thereof, extracting means (9) to extract air and vapor from the baking chamber (2) and a control unit (17) provided with program means programmed to adjust the flow rate of said extracting means (9), the method comprising the steps of:
a) baking the food products in the baking chamber (2) by the heating means, by extracting moisture in the vapor form from them;
b) programming, by the program means, the extracting means to extract an air and vapor flow rate Q from the baking chamber (2);
wherein the air and vapor flow rate Q extracted during step b) is equal to or higher than:
$$Q = \frac{V}{{( {U}_{OUT} - {U}_{IN} )}^{*} {d}_{A}}$$
where:
Q is the volumetric flow rate of air and vapor to be withdrawn from the baking chamber (2) per each kilogram of food products passing through the baking chamber (2) itself,
V is the amount of vapor to be removed per each kilogram of food product passing through the baking chamber (2),
U_{IN} is the specific humidity of the air entering the baking chamber (2),
U_{OUT} is the specific humidity of the air withdrawn from the baking chamber (2),
d_{A} is the air density,
wherein the vapor amount V is the difference between the water content X_{IN} in each kilogram of food product to be baked, inserted in the baking chamber (2), and the water content X_{OUT} being in each kilogram of baked food product extracted from the baking chamber (2), where V=X_{IN}−X_{OUT}, with X_{OUT}<50 grams,
to obtain a baked food product having residual moisture lower than 5% by weight and shelf-life longer than four months at room temperature.

17. The baking method according to claim 16, wherein the flow rate Q is equal to at least 20 m³ per each kilogram of food product passing through the baking chamber (2).

18. The baking method according to claim 16, wherein the baking oven (1) comprises air inflow means (12) for the inflow of air into the baking chamber (2), and wherein the method further comprises: programming, by the program means, the inflow means for the inflow of air into the baking chamber, the air flow rate of the inlet of the inflow means being adjusted on the basis of the volumetric air and vapor flow rate withdrawn from the baking chamber (2) by the extracting means.
